(19) United States
(12) Patent Application Publication
(10) Pub. No.: US 2013/0321328 A1
(43) Pub. Date: Dec. 5, 2013

(54) METHOD AND APPARATUS FOR CORRECTING PEN INPUT IN TERMINAL

(71) Applicant: SAMSUNG ELECTRONICS CO. LTD., Suwon-si (KR)

(72) Inventors: Juhyun AHN, Suwon-si (KR); Youngho CHO, Seoul (KR)

(73) Assignee: Samsung Electronics Co. Ltd., Suwon-si (KR)

(21) Appl. No.: 13/890,579

(22) Filed: May 9, 2013

(30) Foreign Application Priority Data
Jun. 4, 2012 (KR) 10-2012-0059962

(51) Int. Cl. G06F 3/0354

(52) U.S. Cl. CPC G06F 3/03549
USPC 345/174

(57) ABSTRACT

A method of correcting touch input in a terminal is provided. The method includes detecting touched locations of a pen and a hand when a pen touch is input, determining a rotation direction of the terminal and a pen use type of a user by comparing and analyzing the detected touched location of the pen and the hand, and determining a correction value of the pen touch input corresponding to the determined rotation direction and pen use type.

### PRIORITY

This application claims the benefit under 35 U.S.C. §119(a) of a Korean patent application filed on Jun. 4, 2012 in the Korean Intellectual Property Office and assigned Serial No. 10-2012-0059962, the entire disclosure of which is hereby incorporated by reference.

### BACKGROUND OF THE INVENTION

1. Field of the Invention

The present invention relates to an apparatus and a method for correcting touch input. More particularly, the present invention relates to an apparatus for correcting pen touch input and a method thereof.

2. Description of the Related Art

In general, a terminal according to the related art includes a touch panel, and performs operation control of data input of a device. In this case, the touch panel mainly uses a capacitive type and a resistive type technology (e.g., sensor) for detecting finger touch of a user. In this case, when inputting data using a device with the touch panel, a key pad (e.g., Hanguel, English, numeric key pads, and the like) for inputting data is displayed. If a character region on the key pad is touched, the terminal recognizes a touched location to determine input data.

However, in a case in which the touch panel is used, if the key pad is not used, because a finger must be used, characters and pictures may not be precisely input. Accordingly, devices using a pen precisely inputting cursive letters or pictures such as lines have been developed. For example, Electro Magnetic Resonance (EMR) technology developed by Wacom Ltd. may detect pen input through resonance between a Flexible Printed Circuit Board (FPCB) and an EMR dedicated pen by adding an EMR sensor pad under a Liquid Crystal Display (LCD). Hereinafter, a touch panel is illustrated as a panel detecting a finger touch and an Electro Magnetic (EM) panel is illustrated as a panel detecting a pen touch.

In a case of the related art, according to a terminal using the pen touch input, a user must manually set preset values for a right-handed person and a left-handed person through environment setting, and corrects coordinates of a touch panel using display direction information of a screen (e.g., direction information indicating location of the terminal) using an acceleration sensor. However, a pen touch input method according to the related art using a scheme of directly setting left-handed type/right-handed type through a setting menu by the user, if a pen touch input other than a preset user pen type is generated (e.g., pen touch input with respect to a right hand (or left hand) is generated in a state in which a left-handed person (or right-handed person) is set), an error may arise in relation to a correction of touch pen coordinates.

When the user uses a terminal while viewing the terminal in a landscape direction in a state in which a display direction (e.g., a positioned direction of terminal) is a portrait screen mode, or a direction in which the user views the terminal does not correspond to a screen display direction of the terminal, coordinates are collected in a direction in which the user does not intend to input a pen touch input. As a result, there is a difference between coordinated intended by the user and coordinated recognized by the terminal so that the user may recognize a touch pen or the terminal as failure. In particular, when a user uses the terminal in a state in which the terminal is not aligned parallel to a bottom, the user acquires state information of the terminal from an acceleration sensor to perform pen correction in a direction viewing a screen. If the terminal is positioned on the bottom and is aligned parallel to the bottom, because the terminal is unable to determine which direction the user views the terminal as direction information of an acceleration sensor, when the terminal attempts to correct for use of the touch pen, correction error of the touch pen results.

As described above, although a terminal according to the related art processing pen touch input is a set pen use type (e.g., based on whether user is a left-handed person or a right-handed person), when a right-handed type or a left-handed type is set in a setting menu or the user uses a touch pen while viewing the terminal in a landscape direction in a situation that the terminal is displayed in a portrait screen in a state in which the user positions the terminal on a bottom, correction of the touch pen is operation in a display direction of a screen.

Therefore, a need exists for an apparatus and method for automatically correcting pen touch input by analyzing a positioned direction of a terminal using a touch pen and finger touch input and pen use type of a user.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus capable of automatically correcting pen touch input by analyzing a positioned direction of a terminal using a touch pen and finger touch input and pen use type of a user, and a method thereof.

Another aspect of the present invention is to provide a terminal using a touch pen that requires coordinate correction with respect to pen touch input, and a coordinate correction method of pen touch input which varies according to rotation information of a device and pen use type of a user.

Another aspect of the present invention is to provide an apparatus for allowing a user to automatically confirm a pen use type (e.g., left-handed type/right-handed type based on whether the user is left-handed or right-handed) and to set a correction value of pen touch input according to the confirmed information, thereby correcting pen touch input, and a method thereof.

In accordance with an aspect of the present invention, a method of correcting touch input in a terminal is provided. The method includes detecting touched locations of a pen and a hand when a pen touch is input, determining a rotation direction of the terminal and a pen use type of a user by comparing and analyzing the detected touched location of the pen and the hand, and determining a correction value of the pen touch input corresponding to the determined rotation direction and pen use type.

In accordance with another aspect of the present invention, an apparatus for correcting touch input in a terminal is provided. The apparatus includes an Electro Magnetic Resonance (EMR) panel for detecting pen touch input, a touch panel for detecting hand touch input, and a controller for detecting touched locations of a pen and a hand from the EMR panel and the touch panel when the pen touch is input, for determining a rotation direction of the terminal and a pen use type of a user by comparing and analyzing the detected touched location of the pen and the hand, and for determining a correction value of the pen touch input corresponding to the determined rotation direction and pen use type, and a display unit for displaying the touch input under control of the controller.

In accordance with another aspect of the present invention, a system for correcting touch input in a terminal is provided. The system includes a pen, and a terminal configured to detect an input from a hand of a user and to detect an input from the pen, wherein the terminal automatically corrects a location corresponding to the input from the pen based on relative coordinates of the detected input from the hand and the detected input from the pen.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1A and 1B are views illustrating a need for correcting coordinates of a pen touch input in a terminal using pen touch input according to an exemplary embodiment of the present invention;

FIG. 2 is a block diagram illustrating a configuration of a terminal according to an exemplary embodiment of the present invention;

FIG. 3 is a diagram illustrating a method of correcting a pen touch input by comparing and analyzing coordinates of a touch panel touched by a hand with coordinates of a touch pen by a terminal according to an exemplary embodiment of the present invention;

FIG. 4 is a flowchart illustrating a method of correcting a pen touch input by comparing and analyzing a hand touch input with the pen touch input in a terminal according to an exemplary embodiment of the present invention;

FIGS. 5A to 5D are diagrams illustrating examples of correcting coordinates of a touch pen according to a positioned location of a terminal when a user using a pen by a right hand inputs pen touch while performing a procedure for correcting a pen touch input such as, for example, the procedure illustrated in FIG. 4 according to an exemplary embodiment of the present invention;

FIGS. 6A to 6D are diagrams illustrating example of correcting coordinates of a touch pen according to a positioned location of a terminal when a user using a pen by a left hand inputs pen touch while performing a procedure for correcting a pen touch input such as, for example, the procedure illustrated in FIG. 4 according to an exemplary embodiment of the present invention; and

FIG. 7 is a flowchart illustrating a method of correction pen touch input by comparing and analyzing a rotation direction, a pen touch input, and a hand touch input in a terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In general, a device using a touch pen requires correction of coordinates of a pen touch input according to a touched location of a pen and a location of a sensor mounted on the pen. The correction method of coordinates in pen touch input should generally be changed (modified) according to a pen use type (e.g., left-handed type/right-handed type which may be based on whether the user is left-handed or right-handed) of a user or a positioned state of a device (e.g., a direction of a device and a direction in which the user views the terminal). The terminal according to the exemplary embodiment of the present invention uses a pen touch and touch input of a user (e.g., a finger touch input). Exemplary embodiments of the present invention suggest an apparatus for automatically detecting a pen use type of a user (e.g., detecting whether the pen use type is of a left-handed type, a right-handed type, or the like) and a positioned direction of the terminal, and for automatically setting a correction value of a pen touch input according to the detected result to correct coordinates of the pen touch input, and a method thereof. Then, the terminal may prevent touch correction error according to a pen use type of the user without manually setting a pen use type of the user. The terminal may recognize a location of the user to normally correct coordinates of a touch pen although the user uses a touch pen while viewing the terminal in some direction regardless of a positioned state of the terminal (e.g., a display direction of a screen of the user and the terminal).

According to exemplary embodiments of the present invention, the terminal may be a portable terminal. For example, the terminal may refer to mobile devices such as a cellular phone, a Personal Digital Assistant (PDA), a digital camera, a portable game console, and an MP3 player, a Portable/Personal Multimedia Player (PMP), a handheld e-book, a portable lap-top PC, a Global Positioning System (GPS) navigation, and devices such as a desktop PC, a High Definition Television (HDTV), an optical disc player, a setup box, and the like capable of wireless communication or network communication consistent with that disclosed herein.

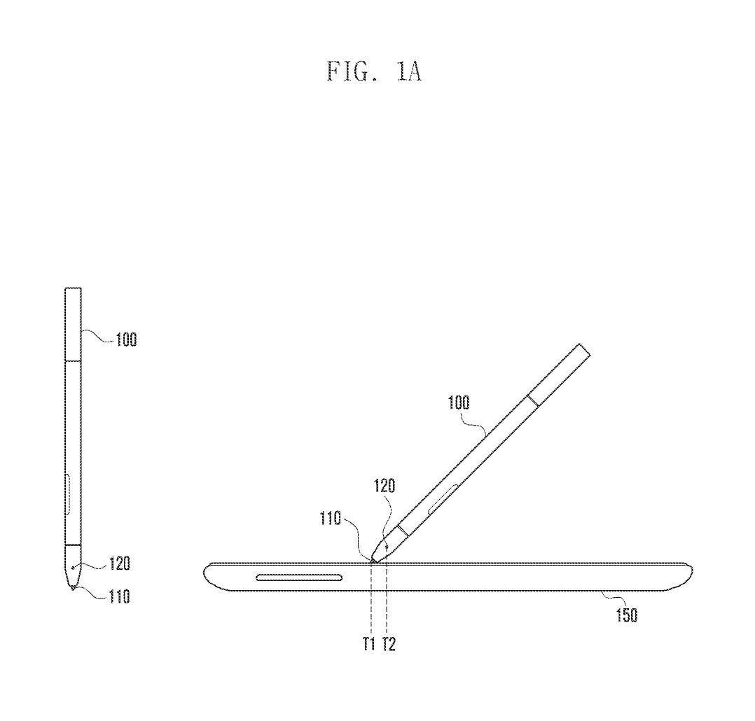

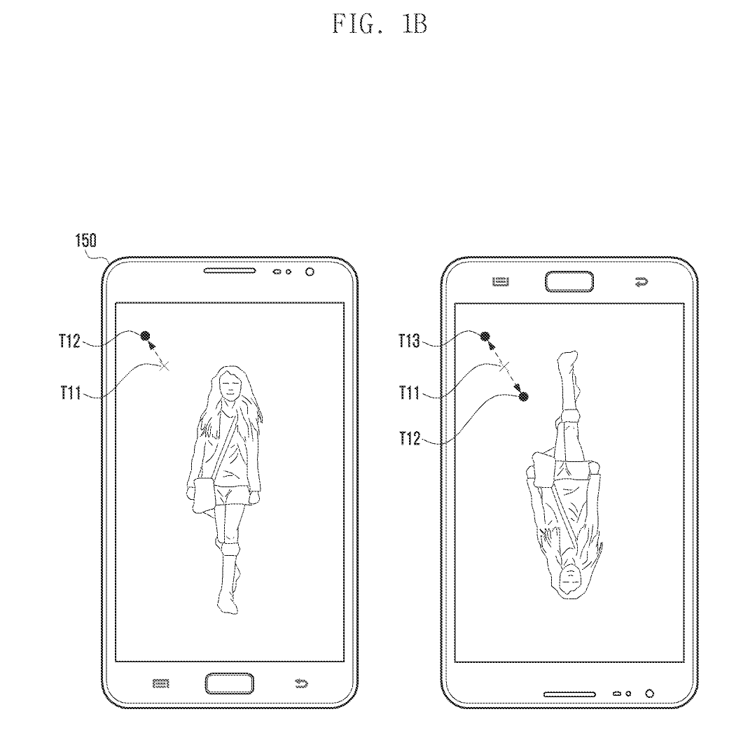

FIGS. 1A and 1B are views illustrating a need for correcting coordinates of a pen touch input in a terminal using pen touch input according to an exemplary embodiment of the present invention.

Referring to FIGS. 1A and 1B, an Electromagnetic induction-type pen 100 is a contactless pen (e.g., the pen may be used for input without being required to contact a surface) using Electro-Magnetic Resonance (EMR), and generates touch input by EMR with a corresponding sensor board (hereinafter referred to as ‘EMR panel’) of the terminal. In this case, as shown in FIG. 1A, a nib 110 of a pen 100 corresponds to an end close to a sensor board (e.g., contacting with or close to the terminal), and the nib 110 may be made by a soft material such as rubber or plastic material. Further, the sensor board of the terminal and a sensor 120 generating EMR may be disposed at a top end of the nib 110. Accordingly, when a touch input is generated using the pen 100, a location between a nib 110 making contact with (or close to) the terminal (e.g., the device in which the sensor board is implemented) and a sensor 120 generating actual pen touch input may be changed. For example, as shown in FIG. 1A, an error may be caused between a location T1 of a nib 110 touched by the user and a location T2 of touch input detected by the sensor 120.

Referring to FIGS. 1A and 1B, as illustrated in relation to terminal 150, a right-handed user touches a location T1 using a pen 110, a terminal detects the touch location as a location T2 by a sensor 120. In this case, the terminal corrects coordinates of the pen touch input to a location T1. For example, as illustrated in reference numeral 160 of FIG. 1B, in a case in which the device is rotated by 180°, if a right-handed user touches a location T11 using a pen 100, the terminal detects the touched location as a location T12 by the sensor 120. In this case, the terminal must correct coordinates of the pen touch input to a location T11. If a rotation state of the device is not recognized, coordinates of pen input are corrected to a location T13. Such an erroneous operation is generated in a case of erroneously recognizing a pen use type of a user. Accordingly, when the pen touch input is corrected, coordinates of pen touch input may be corrected only by recognizing a positioned location of the terminal and a pen use type of the user.

According to exemplary embodiments of the present invention, an apparatus and method for detecting coordinates of a panel by detecting input of a touch pen and coordinates of a Touch Screen Panel (TSP) and by detecting touch input of a user if both of a finger of a user and a touch pen touch the terminal upon using the touch panel, for determining a pen use type of the user and a positioned state of the terminal by comparing and analyzing coordinates information of two detected touch inputs, and for setting a correction direction of pen touch input according to the determined result to correct pen touch input, may be provided.

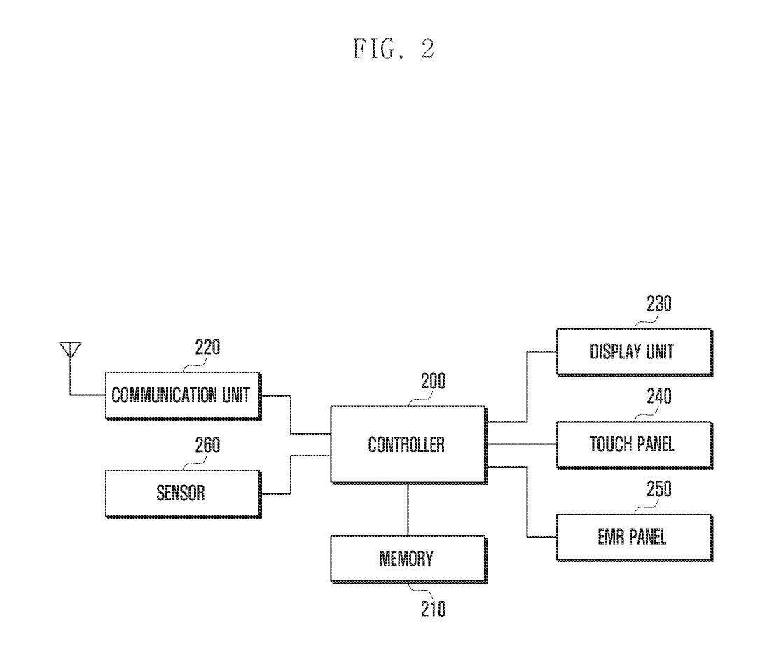

FIG. 2 is a block diagram illustrating a configuration of a terminal according to an exemplary embodiment of the present invention.

Referring to FIG. 2, the terminal may include a controller 200, a memory 210, a communication unit 220, a display unit 230, a touch panel 240, an EMR panel 250, and a sensor 260.

The communication unit 220 performs a wireless communication function with a base station or other devices. The communication unit 220 may include a transmitter up-converting a frequency of a transmitted signal and amplifying the signal, and a receiver low-noise-amplifying a received signal and down-converting the signal. The communication unit 220 may include a modulator and a demodulator. The modulator modulates the transmitted signal and transfers the modulated signal to the transmitted, and the demodulator demodulates a signal received through the receiver. In this case, the modulator and the demodulator may be Long Term Evolution (LTE), Wideband Code Division Multiple Access (WCDMA), Global System for Mobile Communications (GSM), Wi-Fi, WiBro, Near Field Communication (NFC), Bluetooth, and/or the like. It is assumed in the exemplary embodiment of the present invention that the communication unit 220 includes LTE, WIFI, and Bluetooth communication units.

The controller 200 controls an overall operation of the portable terminal. According to exemplary embodiments of the present invention, the controller 200 detects coordinates of a panel detecting pen touch input and touch input of a user upon detection of pen touch, determines a pen use type of the user and a positioned state of the terminal by comparing and analyzing coordinates information of two detected touch inputs, and controls an operation for correcting the pen touch input according to the determined result.

A memory 210 may include a program memory storing an operation program of the terminal and a program according to exemplary embodiments of the present invention, and a data program storing tables for an operation of the terminal and data generated during execution of a program.

A display unit 230 displays information of an executed application under control of the controller 200. The display unit 230 may be an LCD or an OLED. The touch panel 240 may be implemented by a capacitive type and a resistive type. The touch panel 240 outputs location information of a touch (hereinafter, assumed to ‘finger touch’) of the user to the controller 200. The EMR panel 250 includes an EMR sensor pad and detects pen touch input and outputs a detection result to the controller 200. The display unit 230, the touch panel 240, and the EMR panel 250 may be integrally configured with each other.

The sensor 260 detects an operation and a state of the terminal and transfers the detection result to the controller 200. The sensor 260 may include sensors for detecting motion and a rotation state of the terminal. The sensor 260 may be an acceleration sensor, a gyro sensor, a geo-magnetic sensor, and/or the like.

The controller 200 in the portable terminal having a structure as described above displays information on the display unit 230. In a case in which a touch is generated at a specific location of the display unit 230, if the touch is a finger touch, the touch panel 240 outputs touch information to the controller 200. If the touch is a pen touch, the EMR panel 250 outputs pen touch information to the controller 200. The display unit 230, the touch panel 240, and the EMR panel 250 may be integrally configured with each other. According to exemplary embodiments of the present invention, a touch panel 240 may be mounted at an upper portion of the display unit 230 and an EMR panel 250 may be mounted at a lower portion of the display unit 230.

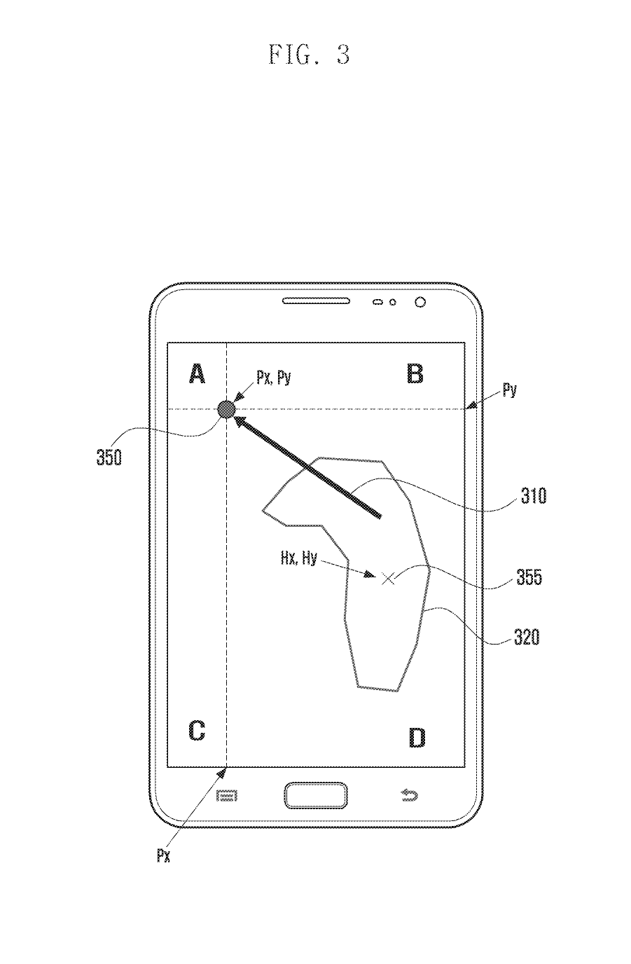

FIG. 3 is a diagram illustrating a method of correcting a pen touch input by comparing and analyzing coordinates of a touch panel touched by a hand with coordinates of a touch pen by a terminal according to an exemplary embodiment of the present invention.

Referring to FIG. 3, a case in which the terminal is located at 0° in a user direction and a pen use type of a user is of a right-hand type, is illustrated.

As illustrated in FIG. 3, upon using the touch pen 310, a finger 320 of a user and the touch pen 310 may respectively touch the terminal as illustrated by reference numerals 355 and 350. Then, the controller 200 may input coordinates of the pen touch location 350 through the EMR panel 250, and input coordinates of the hand touch location 355 through the touch panel 240. The controller 200 may recognize at which location of the terminal the current user uses any hand (e.g., left hand/right hand) by comparing and analyzing two input coordinates. In this case, a screen is divided into four parts based on coordinates (Px, Py) with respect to a touched location 350 of the touch pen 310, and the user may confirm within which one of the four divided screens A, B, C, and D coordinates (Hx, Hy) corresponding to an optional location 355 touched by the hand 320 falls.

In FIG. 3, x coordinates of regions A and B are greater than x coordinates of regions C and D, and y coordinates of the regions B and D are greater than y coordinates of regions A and C. Accordingly, x coordinates of a region 350 in which pen touch input is detected is greater than x coordinates of a region 355 in which hand touch input is detected, and y coordinates of the region 350 in which the pen touch input is detected is less than y coordinates of the region 355 in which the hand touch input is detected. Accordingly, if the user using a right hand touches the pen 310 on the terminal in a state in which the user positions the terminal to have angle of 0° with the user, the controller 200 may confirm that the touch location has coordinates of (Px<Hx) and (Py>Hy). The Px and the Py indicates pen touch coordinates, and the Hx and the Hy indicate hand touch coordinates.

In this case, referring to FIG. 3, if the user touches a pen by a left hand, touched coordinates of the pen 310 and touched coordinates of the hand 320 vary. For example, the pen touch location 350 is shifted to a region B so that x coordinates may be increased, and the hand touch location 355 is shifted to a region C so that the x coordinates may be reduced. Accordingly, as illustrated in FIG. 3, if the pen touch input is generated in a state in which the terminal is located at 0° in a user direction and a pen use type of a user is of a right-hand type, the controller 200 may confirm that the touch location has coordinates of (Px>Hx) and (Py>Hy).

Further, if the terminal is rotated so that a rotation varies (e.g., 90°, 180°, or 270°), even when the user generates pen touch input using the same right hand, the pen and hand touch coordinates vary. For example, x and y axis coordinates vary according to rotation of the terminal thereby resulting in the pen and hand touch coordinates to vary when the terminal is rotated.

According to exemplary embodiments of the present invention, a method of automatically determining a positioned direction of the terminal and a pen use type of a user by confirming a pen touch location and a touched location of a hand holding a pen upon detection of pen touch input, and correcting coordinates of pen touch input using the determined information, is provided.

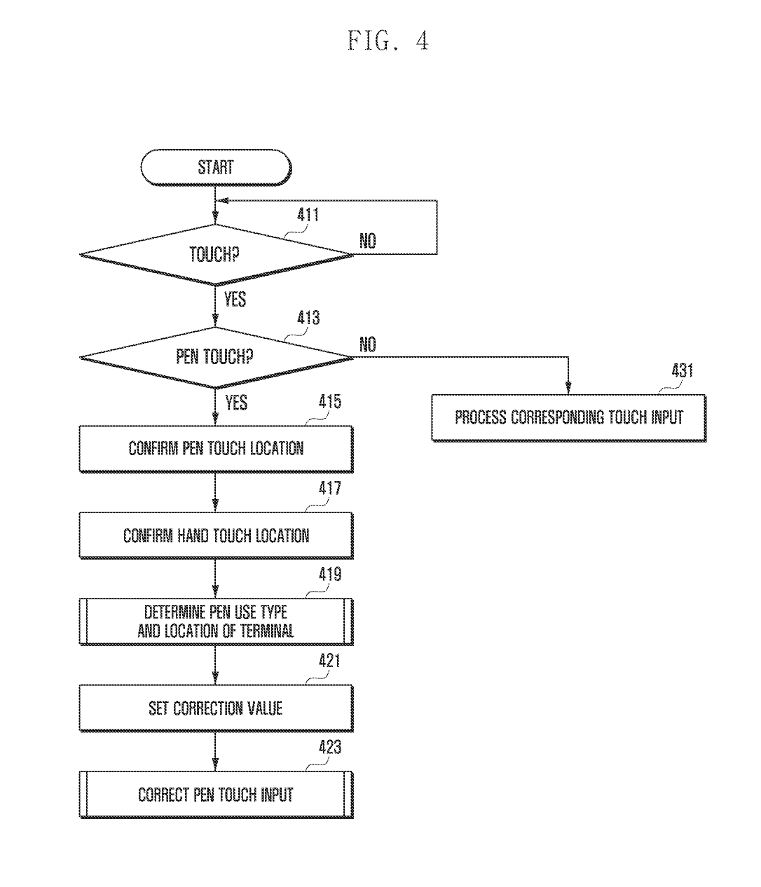

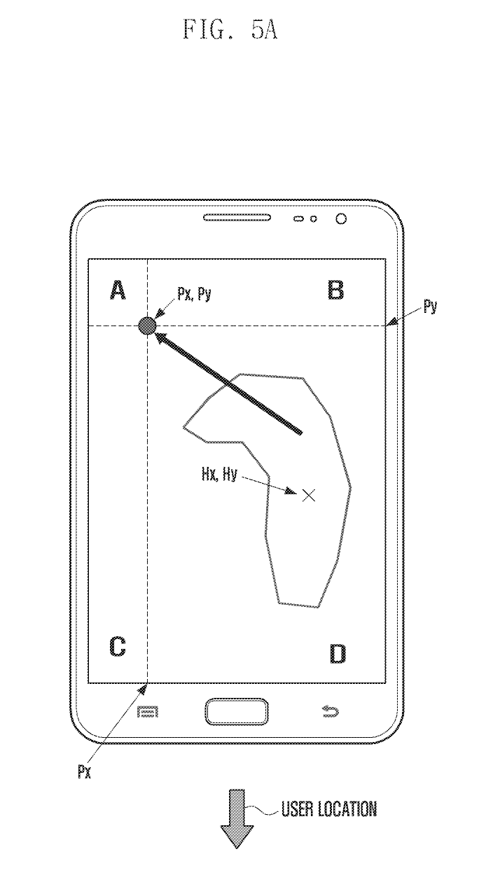

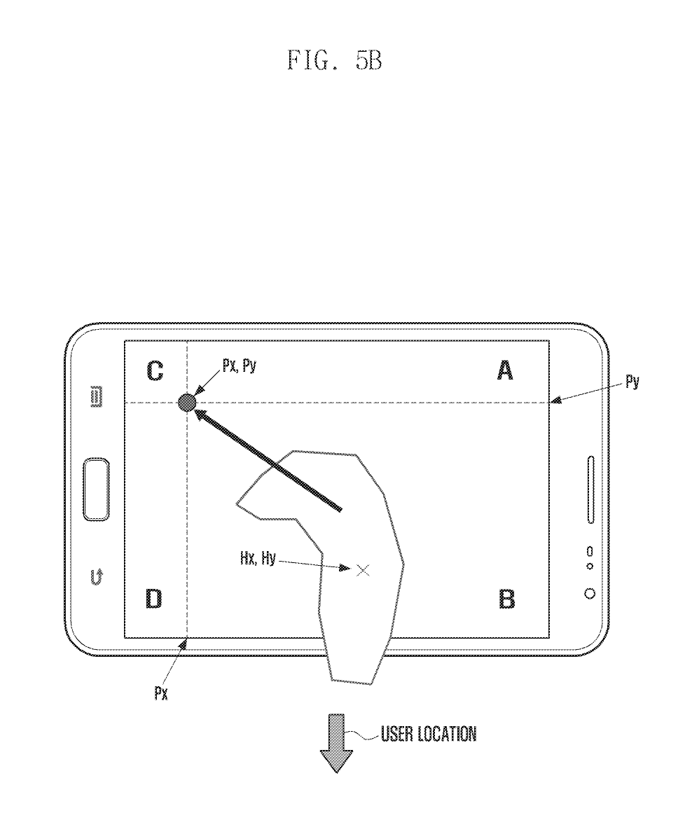

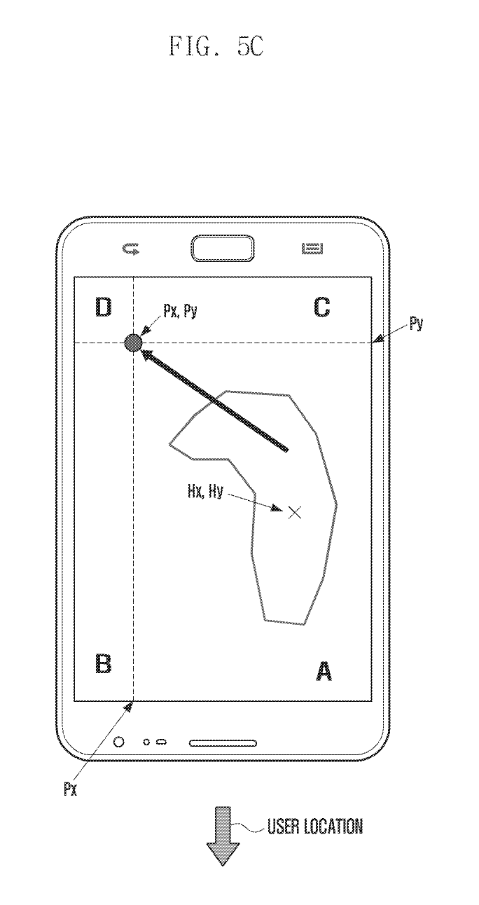

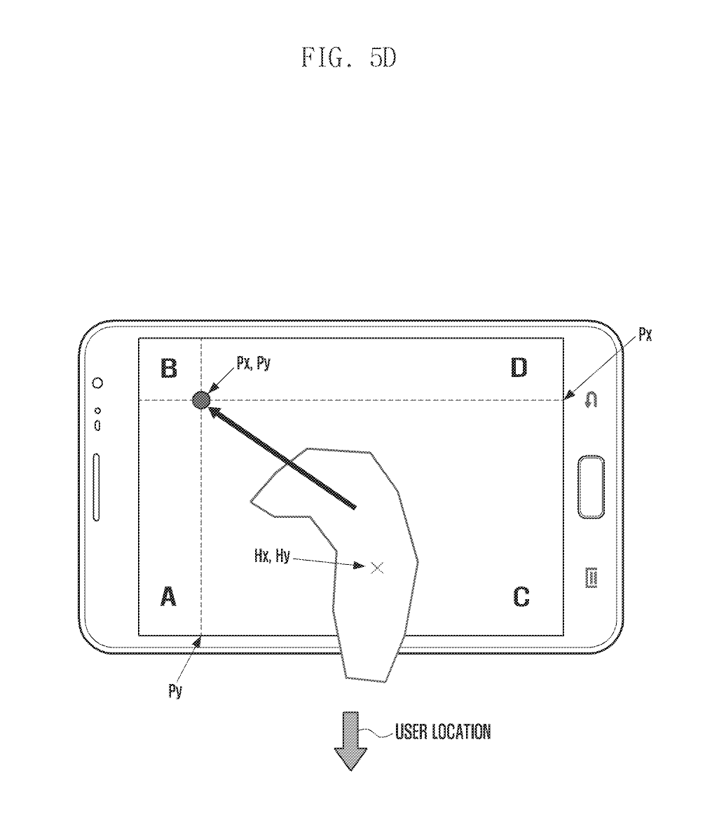

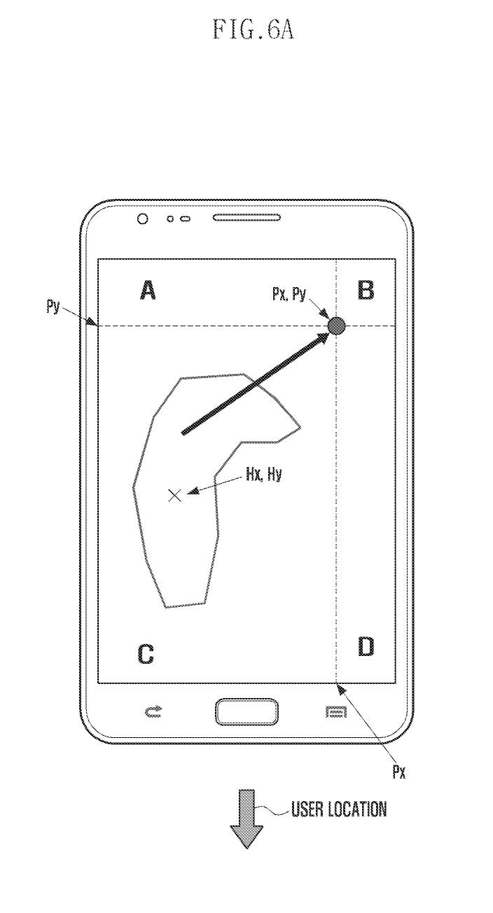

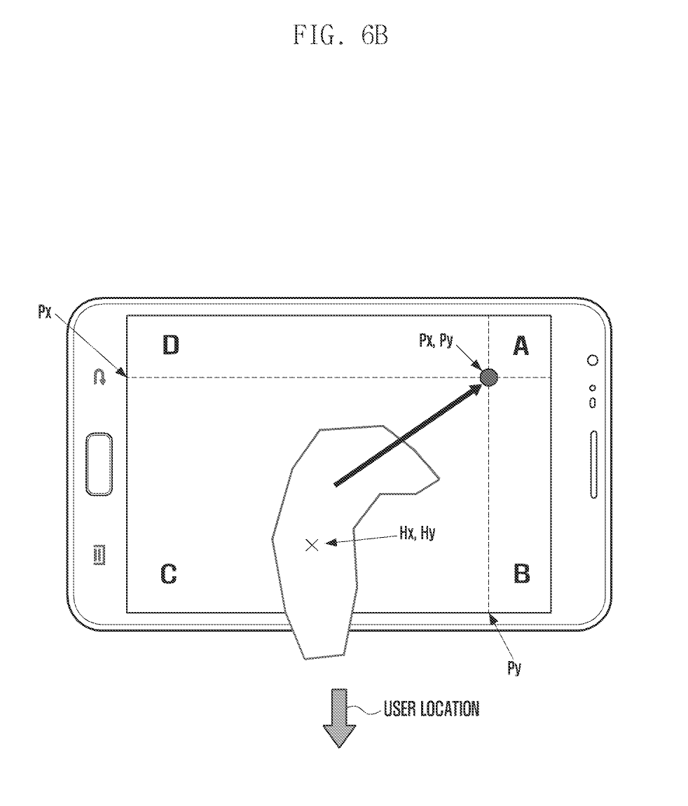

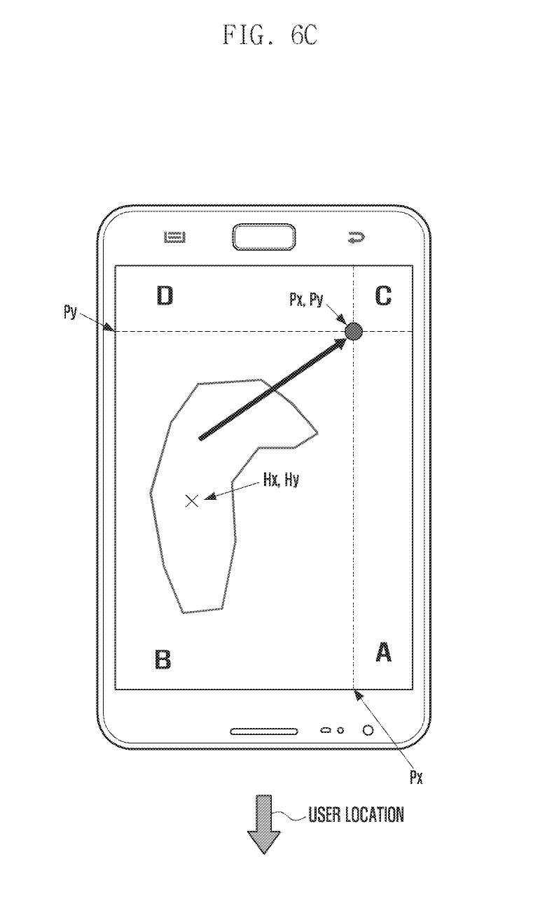

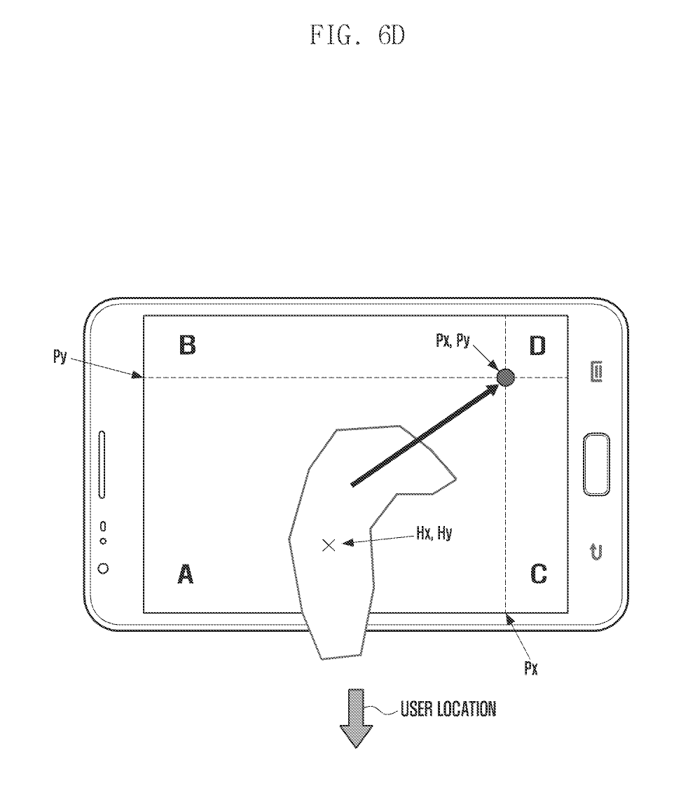

FIG. 4 is a flowchart illustrating a method of correcting a pen touch input by comparing and analyzing a hand touch input with the pen touch input in a terminal according to an exemplary embodiment of the present invention. FIGS. 5A to 5D are diagrams illustrating examples of correcting coordinates of a touch pen according to a positioned location of a terminal when a user using a pen by a right hand inputs pen touch while performing a procedure for correcting a pen touch input such as, for example, the procedure illustrated in FIG. 4. FIGS. 6A to 6D are diagrams illustrating example of correcting coordinates of a touch pen according to a positioned location of a terminal when a user using a pen by a left hand inputs pen touch while performing a procedure for correcting a pen touch input such as, for example, the procedure illustrated in FIG. 4.

Referring to FIGS. 4 to 6D, if touch input is generated, the controller 200 detects the touch input in step 411 and determines whether the touch input corresponds to a pen touch input in step 413. If the controller 200 determines that the touch input is detected through the touch panel 240 then the controller 200 detects that the touch input corresponds to a finger touch input in steps 411 and 413, and processes the corresponding touch input in step 431. However, if the controller 200 determines that the touch input corresponds to the pen touch input (e.g., by the controller 200 detecting the pen touch input through an EMR panel 250 in steps 411 and 413, the controller 200 proceeds to step 415. In step 415, the controller 200 confirms a location in which the pen touch input is generated through the EMR panel 250, and thereafter confirms the touch input location of a hand holding a pen through the touch panel 240 in step 417. Thereafter, in step 419, the controller 200 analyzes coordinates of the two touch inputs to determine a pen use type of the user and a positioned direction of the terminal (rotation direction of the terminal).

Referring to FIGS. 5A to 5D, FIG. 5A illustrates a direction of a terminal in a rotation state of 0° or 360°, FIG. 5B illustrates a direction of a terminal in a rotation state of 90°, FIG. 5C illustrates a direction of a terminal in a rotation state of 180°, and FIG. 5D illustrates a direction of a terminal in a rotation state of 270°. For example, FIGS. 5A to 5D illustrate cases in which the rotation direction of the terminal is first to fourth direction, respectively. The first to fourth directions illustrate cases of having an interval of 90°. It is assumed in FIGS. 5A to 5D that x coordinates of regions A and B are greater than x coordinates of regions C and D, and y coordinates of regions B and D are greater than x coordinates of regions A and C.

Accordingly, even when the user generates pen touch input in the same form while holding a pen, as shown in FIGS. 5A to 5D, the touch may have mutual different pen touch coordinates and hand touch coordinates. The touch may have mutual different pen touch coordinates and hand touch coordinates because the controller 200 varies touch coordinates input from the touch panel 240 and the EMR panel 250 by rotation of the terminal. For example, the pen touch location and the hand touch location in a case of FIG. 5A are described. The hand touch has x coordinates greater than x coordinates of the pen touch and the pen touch has y coordinates greater than y coordinates of the hand touch [(Px<Hx) And (Py>Hy)]. Second, the following is pen and hand touch locations in which the terminal is rotated at 90° in FIG. 5A as illustrated in FIG. 5B. The x and y coordinates of the hand touch are greater than those of the pen touch. Third, as illustrated in FIG. 5C, when the terminal is rotated at 180° in FIG. 5A, the pen touch has x coordinates greater than x coordinates of the hand touch and the hand touch has y coordinates greater than y coordinates of the pen touch[(Px>Hx) And (Py<Hy)]. Fourth, as illustrated in FIG. 5D, pen and hand touch locations where the terminal is rotated at 270° is described. The x and y coordinates of the pen touch are greater than those of the hand touch [(Px>Hx) and (Py>Hy)].

Accordingly, when a pen use type of the user is a right-handed type, four cases as listed in Table 1 are created according to a positioned direction of the terminal.

TABLE 1

| | Direction | Pen use | Correction | |
|---|---|---|---|---|
| Analysis result | of terminal | type | Location | Drawings |
| (Px < Hx), (Py > Hy) | First | Right- | A | FIG. 5A |
| | direction: 0°, | handed | direction | |
| | 360° | | | |
| (Px < Hx), (Py < Hy) | Second | Right- | C | FIG. 5B |
| | direction: 90° | handed | direction | |
| (Px > Hx), (Py < Hy) | Third | Right- | D | FIG. 5C |
| | direction: 180° | handed | direction | |
| (Px > Hx), (Py > Hy) | Fourth | Right- | B | FIG. 5D |
| | direction: 270° | handed | direction | |

Further, in a case of a user using a touch pen by a left hand, as shown in FIGS. 6A to 6D, the pen touch location and the hand touch location of the left-handed user may be different from those of the right-handed user.

In this case, when the pen use type of the user is a left-handed type, four cases as listed in Table 2 are created according to a positioned direction of the terminal. FIGS. 6A to 6D illustrate cases in which the rotation direction of the terminal is first to fourth direction, respectively. The first to fourth directions illustrate cases of having a 90° interval.

TABLE 2

| | Direction | Pen use | Correction | |
|---|---|---|---|---|
| Analysis result | of terminal | type | location | Drawings |
| (Px > Hx), (Py > Hy) | First | Left- | B | FIG. 6A |
| | direction: 0°, | handed | direction | |
| | 360° | | | |
| (Px < Hx), (Py > Hy) | Second | Left- | A | FIG. 6B |
| | direction: 90° | handed | direction | |
| (Px < Hx), (Py < Hy) | Third | Left- | C | FIG. 6C |
| | direction: 180° | handed | direction | |
| (Px > Hx), (Py < Hy) | Fourth | Left- | D | FIG. 6D |
| | direction: 270° | handed | direction | |

Analysis results of Table 1 and Table 2 are described. First, when a rotation direction of the terminal has a terminal direction at 0°, y coordinates have the same result regardless of left and right-handed types, but x coordinates are different. Second, when the rotation direction of the terminal has a terminal direction at 90°, x coordinates have the same result regardless of left and right-handed types, but y coordinates are different. Third, when the rotation direction of the terminal has a terminal direction at 180°, y coordinates have the same result regardless of left and right-handed types, but x coordinates are different. Fourth, when the rotation direction of the terminal has a terminal direction at 270°, x coordinates have the same result regardless of left and right-handed types, but y coordinates are different. Accordingly, a touch is generated by both of the touch pen and the hand, the controller 200 may detect different values according to a pen use type of a user as illustrated in Table 3 by comparing coordinates (Px, Py) of the touch pen and coordinates (Hx, Hy) of the touch, and may detect whether the user is a left-handed person or a right-handed person using the detection result.

TABLE 3

| Direction of terminal | Left-handed | Right-handed |
|---|---|---|
| First direction: 0°, 360° | (Px > Hx) | (Px < Hx) |
| Second direction: 90° | (Py > Hy) | (Py > Hy) |
| Third direction: 180° | (Px < Hx) | (Px > Hx) |
| Fourth direction: 270° | (Py < Hy) | (Py > Hy) |

Referring back to FIG. 4, after determining a direction of the terminal and a pen use type of the user by analyzing the pen touch and hand touch location coordinates, the controller 200 sets a correction direction and a correction value of the pen input in step 421. In this case, the correction value may be previously set and stored in the memory 210. The correction value of the pen input may be determined by experimentally measuring a location touched by the user (e.g., a touched location of a nib of a pen) and a distance and an angle of a location detected by a sensor of a pen according to tilt of the pen when the user uses pen input. As described above, the correction direction of the pen input is determined according to a rotation state (positioned state) of the terminal and a pen use type of the user. For example, as listed in Table 1 and Table 2, the correction direction of the pen input may be changed according to the positioned state (rotation state) of the terminal and the pen use type of the user. Accordingly, if the pen use type and the location of the terminal are determined in step 419, the controller 200 determines the correction direction of the pen input according to the determined pen use type and the direction of the terminal in step 421, and thereafter, corrects the pen input location based on the determined correction direction and the set pen input location correction value in step 423.

As described above, the controller 200 confirms in which direction the user uses the terminal using the pen touch location and hand touch location information upon detection of the pen input, and may correct coordinates of the touch pen input in a direction which an actual user views the terminal regardless of a display direction of the terminal.

In addition, the rotation direction of the terminal may be determined using the sensor 260. The sensor 260 may be an acceleration sensor, a geo-magnetic sensor, and/or the like. When touches are simultaneously generated by a touch pen and the touch panel 240 in a state in which screen rotation information of the acceleration sensor where the terminal is not aligned parallel to a bottom is valid, the controller 200 compares coordinates (Px, Py) of a touch pen detected from the EMR panel 250 and coordinates (Hx, Hy) of a touch detected by the touch panel 240 as listed in Table 1 and Table 2 to determine whether the user is a left-handed person or a right-handed person.

The controller 200 may determine whether the terminal is rotated through the foregoing relation equation when the terminal is rotated at a specific angle or higher using a value of a gyro sensor in a state the terminal is provided parallel to the bottom. According to exemplary embodiments of the present invention, the terminal recognizes a left hand, a right hand, and a rotation direction of the terminal through the size relation between coordinates of a touch pen and touched coordinates. A touch pen driver may be converted into a proper correction data table by automatically searching direction information while minimizing a loader of a driver stage and providing rotation information and information of a user hand to a touch pen driver in necessary. When information of the sensor 260 (e.g., acceleration sensor) is invalid (e.g., when the terminal is positioned on a bottom, or when the terminal rests on a surface), a rotation state of a terminal coordinate system may be detected based on a user.

According to exemplary embodiments of the present invention, the controller 200 detects touched locations of the pen and the hand upon input of the pen touch through an EMR panel 250 and a touch panel 240. The controller 200 determines a rotation direction of a device and a pen use type of the user by comparing and analyzing the detected pen and hand touched locations, and determines a correction value of pen touch input corresponding to the determined rotation direction and pen use type. The controller 200 sets a correction value of the pen touch input and thereafter corrects the pen touch input as a correction value set upon input of the pen touch.

In this case, a procedure of determining the rotation direction and the pen use type by the controller 200 compares X coordinates of the pen touch with X coordinates of the hand touch, and compares Y coordinates of the pen touch with Y coordinates of the hand touch, and determines the rotation direction of the terminal and the pen use type according to the compared X coordinates and Y coordinates. In this case, the rotation direction is determined as one of four directions (first to fourth directions) at an interval of 90°, and determines the pen use type as a right-handed type or a left-handed type.

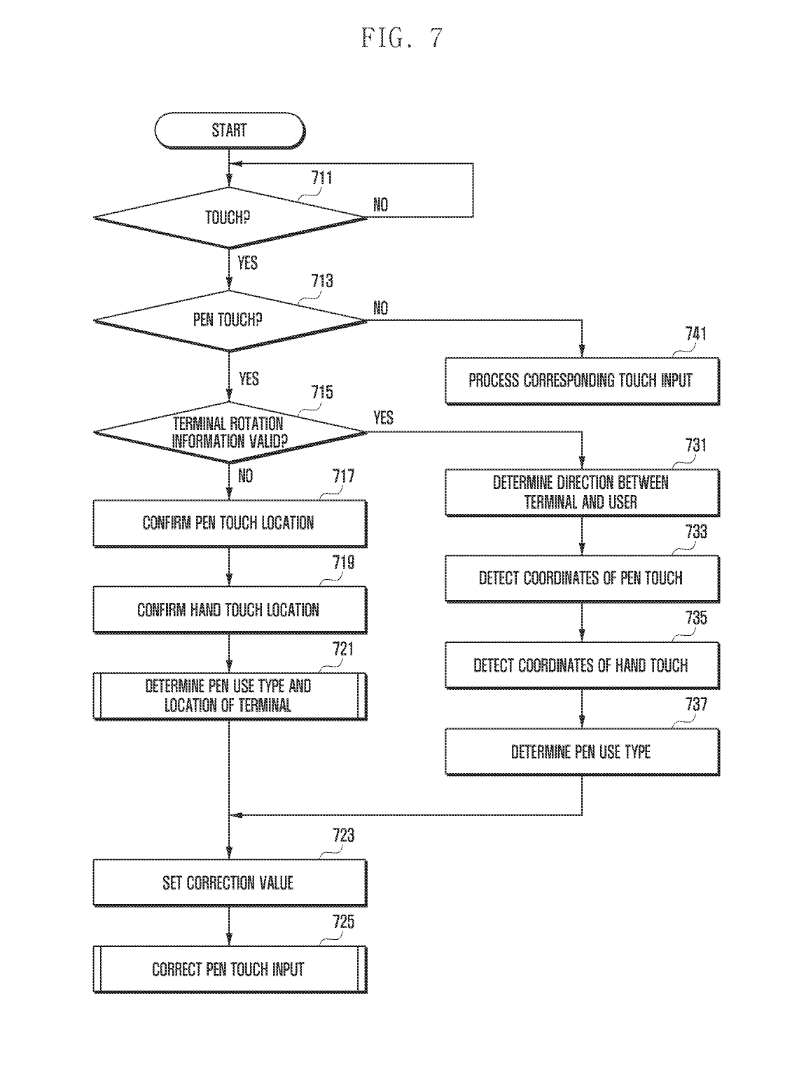

FIG. 7 is a flowchart illustrating a method of correction pen touch input by comparing and analyzing a rotation direction, a pen touch input, and a hand touch input in a terminal according to an exemplary embodiment of the present invention.

Referring to FIG. 7, the sensor 260 detects a positioned location of the terminal and outputs the detection result to the controller 200. In this case, state information of the terminal (e.g., a positioned state of the terminal in a direction of the user according to rotation of the terminal) output from the sensor 260 may be invalid. For example, when the terminal is rotated at a predetermined angle (e.g., 30°) or less, a gyro sensor may generate invalid rotation information. When an acceleration sensor is aligned horizontal to a bottom and becomes a parallel state, information of the acceleration sensor may be invalid. Accordingly, in FIG. 7, when rotation detection information of the sensor 260 is valid, the terminal uses an output of the sensor 260 as rotation information of the terminal. Otherwise, rotation information of the terminal is determined using only pen location and touch location information.

As illustrated in FIG. 7, if touch input is generated, the controller 200 detects the touch input in step 711 and determines whether the touch input corresponds to a pen touch input in step 713. If the controller 200 determines that the touch input is detected through the touch panel 240 then the controller 200 detects that the touch input is finger touch input in steps 711 and 713, and processes the corresponding touch input in step 741. However, if the controller 200 determines that the touch input corresponds to the pen touch input (e.g., by the controller 200 detecting the pen touch input through an EMR panel 250) in steps 711 and 713, the controller 200 proceeds to step 715. In step 715, the controller 200 determines whether terminal rotation information detected by the sensor 260 is valid. When the terminal rotation information detected by the sensor 260 is invalid in step 715, the controller 200 proceeds to steps 717 to 721 in which the controller 200 determines a pen use type of a user and a rotation direction of the terminal by detecting the coordinates of the pen touch and the coordinates of the hand touch, and comparing the detected coordinates of the pen touch and the hand touch with each other. For example, in schemes of the Table 1 and the Table 2, the controller 200 determines a positioned state (rotation state) of the terminal in a user direction and determines use of a right hand/left hand of the user by comparing and analyzing coordinates of the pen touch and the hand touch. Operations of steps 717 to 721 may be performed in the same manner as in the operations of steps 415 to 419. Thereafter, the controller 200 proceeds to steps 723 and 725 in which the controller 200 determines a correction direction according to the determined pen use type and terminal location, and corrects a location of the pen input based on the determined correction direction and the preset location correction value of the pen input.

Conversely, if the rotation information of the terminal detected by the sensor 260 is valid in step 715, the controller 200 proceeds to step 731 in which the controller 200 determines a direction between the terminal and the user according to corresponding rotation information. Subsequently, the controller 200 detects coordinates of the pen touch through the EMR panel 250 in step 733 and detects coordinates of the hand touch in step 735. The controller 200 determines a pen use type of the user according to the coordinates of the pen touch and the coordinates of the hand touch in step 737. Thereafter, the controller 200 proceeds to steps 723 and 726 in which the controller 200 determines a correction direction according to the determined pen use type and terminal location, and corrects a location of the pen input based on the determined correction direction and the preset location correction value of the pen input.

According to exemplary embodiments of the present invention, the controller 200 may determine whether rotation direction information of a terminal detected by the sensor 260 upon input of the pen touch is valid. In this case, when the rotation direction information is invalid, the controller 200 detects touched locations of the pen and the hand through the EMR panel 250 and the touch panel 240, determines a rotation direction of the device and a pen use type of the user by comparing and analyzing the detected touch locations of the pen and the hand, and determines a correction value of pen touch input corresponding to the determined rotation direction and the pen use type. Conversely, when the rotation direction information is valid, the controller 200 detects a rotation direction of the terminal from the sensor, detects touched locations of the pen and the hand to determine a pen use type of the user, and determines a correction value of the pen touch input corresponding to the determined rotation direction and pen use type. The controller 200 sets the correction value of the pen touch input and then corrects the pen touch input as a correction value set upon input of the pen touch.

In this case, a procedure of determining the rotation direction and the pen use type by the controller 200 compares X coordinates of the pen touch with X coordinates of the hand touch, and compares Y coordinates of the pen touch with Y coordinates of the hand touch, and determines the rotation direction of the terminal and the pen use type according to the compared X coordinates and Y coordinates. In this case, the rotation direction is determined as one of four directions (first to fourth directions) at an interval of 90°, and determines the pen use type as a right-handed type or a left-handed type.

According to the exemplary embodiment of the present invention, a terminal for processing pen touch input can correct coordinates of a touch pen when a user pen type is wrongly set in the terminal (e.g., a right-handed user sets a pen use type as a left-handed type or a left-handed user sets a pen use type as a right-handed type), or the user optionally rotates the terminal to use a touch pen in a state in which the terminal is provided parallel to a bottom, and accordingly can increase accuracy of the touch pen input. Particularly, when the users uses the touch pen in a state in which the user views the terminal in a direction opposite to a screen direction of the terminal, correction error of the touch pen can be reduced.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of correcting touch input in a terminal, the method comprising:
detecting touched locations of a pen and a hand when a pen touch is input;
determining a rotation direction of the terminal and a pen use type of a user by comparing and analyzing the detected touched location of the pen and the hand; and
determining a correction value of the pen touch input corresponding to the determined rotation direction and pen use type.

2. The method of claim 1, further comprising:
setting the correction value of the pen touch input; and
correcting the pen touch input as a correction value set when the pen touch is input.

3. The method of claim 2, wherein the determining of the rotation direction of the terminal and the pen use type of the user comprises:
comparing X coordinates of the pen touch with X coordinates of the hand touch;
comparing Y coordinates of the pen touch with Y coordinates of the hand touch; and
determining of the rotation direction of the terminal and the pen use type of the user according to the compared X and Y coordinates.

4. The method of claim 3, wherein the rotation direction of the terminal corresponds to one of four directions of a 90° interval, and the pen use type corresponds to a right-handed type or a left-handed type.

5. The method of claim 4, wherein the determining of the rotation direction of the terminal and the pen use type of the user is determined according to the following table, and wherein the rotation direction has a 90° interval.

| Comparison | | |
|---|---|---|
| analysis result | Direction of terminal | Pen use type |
| (Px < Hx), (Py > Hy) | First rotation direction | Right-handed |
| (Px < Hx), (Py < Hy) | Second rotation direction | Right-handed |
| (Px > Hx), (Py < Hy) | Third rotation direction | Right-handed |
| (Px > Hx), (Py > Hy) | Fourth rotation direction | Right-handed |

6. The method of claim 4, wherein the determining of the rotation direction of the terminal and the pen use type of the user is determined according to the following table, and wherein the rotation direction has a 90° interval.

| Analysis result | Direction of terminal | Pen use type |
|---|---|---|
| (Px > Hx), (Py > Hy) | First rotation direction | Left-handed |
| (Px < Hx), (Py > Hy) | Second rotation direction | Left-handed |
| (Px < Hx), (Py < Hy) | Third rotation direction | Left-handed |
| (Px > Hx), (Py < Hy) | Fourth rotation direction | Left-handed |

7. The method of claim 2, further comprising:
detecting the rotation direction of the terminal when the pen touch is input;
detecting touched locations of the pen and the hand; and
determining a correction value of the pen touch input corresponding to the detected rotation direction and the determined pen use type.

8. The method of claim 7, wherein the detecting of the rotation direction of the terminal and the pen use type of the user comprises:
detecting X and Y coordinates of the pen touch;
detecting X and Y coordinates of the hand touch;
comparing X coordinates of the pen touch with X coordinates of the hand touch;
comparing Y coordinates of the pen touch with Y coordinates of the hand touch; and
determining of the rotation direction of the terminal and the pen use type of the user according to the compared X and Y coordinates.

9. The method of claim 8, wherein the rotation direction of the terminal corresponds to one of four directions of a 90° interval, and
wherein the pen use type corresponds to a right-handed type or a left-handed type.

10. An apparatus for correcting touch input in a terminal, the apparatus comprising:
an Electro Magnetic Resonance (EMR) panel for detecting a pen touch input;
a touch panel for detecting a hand touch input; and
a controller for detecting touched locations of a pen and a hand from the EMR panel and the touch panel when the pen touch is input, for determining a rotation direction of terminal and a pen use type of a user by comparing and analyzing the detected touched location of the pen and the hand, and for determining a correction value of the pen touch input corresponding to the determined rotation direction and pen use type; and
a display unit for displaying the touch input under control of the controller.

11. The apparatus of claim 10, wherein the controller sets the correction value of the pen touch input and corrects the pen touch input as a correction value set when the pen touch is input.

12. The apparatus of claim 11, wherein the controller compares X coordinates of the pen touch with X coordinates of the hand touch, compares Y coordinates of the pen touch with Y coordinates of the hand touch, and determines of the rotation direction of the terminal and the pen use type of the user according to the compared X and Y coordinates.

13. The apparatus of claim 12, wherein the controller determines the rotation direction of the terminal as corresponding to one of four directions of a 90° interval, and determines the pen use type as corresponding to a right-handed type or a left-handed type.

14. The apparatus of claim 11, further comprising:
a sensor for detecting a rotation direction of the terminal,
wherein the controller detects the rotation direction of the terminal when the pen touch is input, detects touched locations of the pen and the hand, and determines a correction value of the pen touch input corresponding to the detected rotation direction and determined pen use type.

15. The apparatus of claim 14, wherein the sensor comprises at least one of a geo-magnetic sensor and an acceleration sensor.

16. A system for correcting touch input in a terminal, the system comprising:
a pen; and
a terminal configured to detect an input from a hand of a user and to detect an input from the pen,
wherein the terminal automatically corrects a location corresponding to the input from the pen based on relative coordinates of the detected input from the hand and the detected input from the pen.

17. The system of claim 16, wherein the terminal automatically corrects the location corresponding to the input from the pen by determining a correction value of the pen touch input corresponding to the determined rotation direction and pen use type.

18. The system of claim 16, wherein the terminal automatically corrects the location corresponding to the input from the pen further based on an orientation of the terminal.
